(19) United States
(12) Patent Application Publication
(10) Pub. No.: US 2010/0138567 A1
(43) Pub. Date: Jun. 3, 2010

(54) APPARATUS, SYSTEM, AND METHOD FOR TRANSPARENT ETHERNET LINK PAIRING

(75) Inventors: Jeffrey D. Haggar, Holly Springs, NC (US); Maurice Isrel, JR., Raleigh, NC (US); Bruce H. Ratcliff, Red Hook, NY (US); Jerry W. Stevens, Raleigh, NC (US); Edward Zebrowski, JR., Raleigh, NC (US)

Correspondence Address: IBM CORPORATION, 3039 CORNWALLIS RD., DEPT. T81 / B503, PO BOX 12195, RESEARCH TRIANGLE PARK, NC, 27709, US

(73) Assignee: INTERNATIONAL BUSINESS MACHINES CORPORATION, Armonk, NY (US)

(21) Appl. No.: 12/326,570

(22) Filed: Dec. 2, 2008

(51) Int. Cl. G06F 3/00; G06F 15/16

(52) U.S. Cl. 710/29; 709/233

(57) ABSTRACT

A solution for reducing latency in a host computing device communicating with network-attached devices over a network. The host includes two network adapters that each support bidirectional communications with the host. The solution includes a dual module that represents the two network adapters as a single logical interface to both the host and the network-attached devices. An inbound module directs inbound data sent to the interface by the devices through one of the network adapters, while an outbound module directs outbound data sent to the interface by the host through the other. In one embodiment, the outbound module is responsible for intercepting data sent to the interface and sending it through the network adapter dedicated to outbound communications. The solution also includes a mode module to enable the latency reduction apparatus, and a collapse module that enables bidirectional communications through the remaining network adapter if a network adapter fails.

### BACKGROUND OF THE INVENTION

1. Field of the Invention

This invention relates to pairing two physical Ethernet ports together, and more particularly relates to combining two separate physical Open System Adapters (OSA) in an IBM z/OS environment such that the two function as a single logical network adapter.

2. Description of the Related Art

Network latency, the time that it takes for data (such as a data packet) to travel from a source to a destination, can be a serious problem in a computing or network environment. For example, network latency can be a significant factor in transactions that require an exchange of lengthy sequences of request response flows before the transaction completes. Unacceptably high network latency can have a negative impact on the overall performance of a network.

Network latency concerns can be of particular concern in mainframe computing environments. Mainframes are designed to handle very high volume input and output (I/O) which often comes over a network. IBM's System z series includes a physical Ethernet port and corresponding network interface card (NIC) that are integrated into a single network adapter called the open systems adapter (OSA). Certain OSA include a single processor and associated storage and I/O facilities that enable it to interface with the host and the network. Thus, the OSA provides the host with access to the external network (such as a LAN) and similarly facilitates communications from the network to the host.

In short, the OSA services both inbound and outbound directions concurrently to enable the bidirectional communication capabilities of Ethernet. However, the OSA can only process traffic in one direction at a time, and must regularly engage in context switching, which is switching from inbound to outbound processing and vice versa. For example, while the OSA is servicing outbound data from the host, inbound data is delayed until the OSA completes processing the outbound data and can switch to inbound data processing. Latency is introduced every time the OSA needs to context switch from inbound to outbound or from outbound to inbound. The overhead of performing the switch, in combination with other OSA responsibilities such as processing traffic caused by OSA sharing among logical partitions, injects latency into the system.

What is needed is a solution that reduces latency in a system with a single processor (such as that implemented in the OSA) for performing context switching. Ideally, such a solution would not require a major reengineering of the relevant hardware or requiring a major change in the system architecture. The solution is also ideally transparent to the host and to the network, such that major changes at the interfaces are not necessary.

### SUMMARY OF THE INVENTION

The present invention has been developed to provide an apparatus, method and system for reducing latency in communications between a host and devices attached to the host by a network. The apparatus includes a dual module, an inbound module, and an outbound module.

The dual module is configured to represent a first network adapter and a second network adapter as a single logical interface to the host that comprises the two network adapters and to devices that communicate data with the host over a network. The first network adapter includes a NIC with a port and supports bidirectional communications such as Ethernet. In certain embodiments, the host is connected to the network by a bidirectional Ethernet connection compliant with the Ethernet protocol. The second network adapter also includes a NIC with a port and similarly supports bidirectional communications. The network adapters, in one embodiment, are Open System Adapters (OSAs) that are in use in the IBM Z series mainframe computers.

In one embodiment, the dual module represents the first and second network adapters as a single logical interface by advertising to the network and to the host the MAC address of the first network adapter and hiding from the network and the host the MAC address of the second network adapter.

The inbound module directs inbound data sent to the single logical interface by the network-attached devices exclusively through the first network adapter. The outbound module directs outbound data sent to the single logical interface by the host exclusively through the second network adapter. In one embodiment, directing outbound data exclusively through the second network adapter involves the outbound module intercepting outbound data sent by the host to the first network adapter and directing that outbound data exclusively through the second network adapter.

In one embodiment, the first network adapter is optimized for inbound data communications and the second network adapter is optimized for outbound data communications. This may involve the first network adapter being optimized based on interrupt optimization for the inbound direction, and the second network adapter being optimized using interrupt optimization for the outbound direction.

In one embodiment, the dual module, inbound module, and outbound module are implemented at the device driver level of the host computing device. In a further embodiment, the apparatus includes a mode module that activates the dual module, inbound module, and outbound module in response to the host's user selecting a latency reduction mode for the host. The mode module is further configured to deactivate the dual module, inbound module, and outbound module in response to the user selecting a normal mode for the host.

In one embodiment, the apparatus also includes a collapse module that enables bidirectional communication through an operational network adapter in response to the first network adapter or the second network adapter failing while the host is in latency reduction mode. Enabling bidirectional communication involves directing inbound data sent to the host by one or more devices over the network through the operational network adapter and directing outbound data sent by the host to one or more devices on the network through the operational network adapter such that the network adapter repeatedly switches direction to communicate both the inbound and outbound data.

Also disclosed is a system for reducing latency where the network adapters are Open System Adapter (OSA) cards. The system includes a first OSA that includes one processor, a port, and a NIC. The first OSA supports bidirectional Ethernet communications and is optimized for inbound data communications using interrupt optimization. The system includes a second OSA with one processor, a port, and a NIC. The second OSA also supports bidirectional Ethernet and is optimized for outbound data communications using interrupt optimization.

A dual module represents the first OSA and the second OSA as a single logical interface to the host and to devices communicating data with the host over the Ethernet connection. An inbound module directs the inbound data exclusively through the first OSA, and an outbound module intercepts outbound data sent by the host to the network devices through the first OSA and redirects the outbound data exclusively through the second OSA. The system may also include a dual module and a collapse module as described above.

The present invention also includes a method for reducing latency in communications over a network that includes representing a first and second network adapter as a single logical interface to the host that includes the network adapters. The first network adapter includes a port, NIC, and only one CPU, as does the second network adapter.

The method includes directing inbound data packets originating on the network and addressed to the host exclusively through the first network adapter such that no inbound data packets pass through the second network adapter. The method also includes intercepting outbound data packets sent by the host to the first network adapter prior to the outbound data packets reaching the first network adapter and then directing the outbound data packets exclusively through the second network adapter such that no outbound data passes through the first network adapter. The inbound data is data that originates with the host and is addressed to one or more devices on the network.

The present invention is described in greater detail below.

### BRIEF DESCRIPTION OF THE DRAWINGS

Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating one embodiment of a system including a host with a latency reduction apparatus;

FIG. 2 is a schematic block diagram of a host computing device with a latency reduction apparatus;

FIG. 3 is a second schematic block diagram of a host computing device with a latency reduction apparatus;

FIG. 4 is a schematic block diagram of an implementation of the latency reduction apparatus; and

FIG. 5 is a flow chart diagram illustrating a method for reducing latency in a system including a host and network-attached devices.

### DETAILED DESCRIPTION OF THE INVENTION

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. In such an embodiment, the module is stored in a computer-readable storage medium such as memory, CD, or other medium known to those in the art. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and maybe embodied in any suitable form and organized within any suitable type of data structure. The operational data may be collected as a single data set, or may be distributed over different locations including over different storage devices. Thus, a module is either software stored in a computer readable medium, a hardware/firmware-implemented circuit, or some combination of the two.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

As will be appreciated by one skilled in the art, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium.

Any suitable computer usable or computer readable medium maybe utilized. The computer-usable or computer-readable medium may be, for example but not limited to, an electronic, magnetic, optical, electromagnetic, or semiconductor system, apparatus, device. More specific examples (a non-exhaustive list) of the computer-readable medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a transmission media such as those supporting the Internet or an intranet, or a magnetic storage device. In the context of this document, a computer-usable or computer-readable medium may be any medium that can contain, store, communicate, or transport the program for use by or in connection with the instruction execution system, apparatus, or device. The computer usable program code may be transmitted using any appropriate medium, including but not limited to the Internet, etc.

Computer program code for carrying out operations of the present invention maybe written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

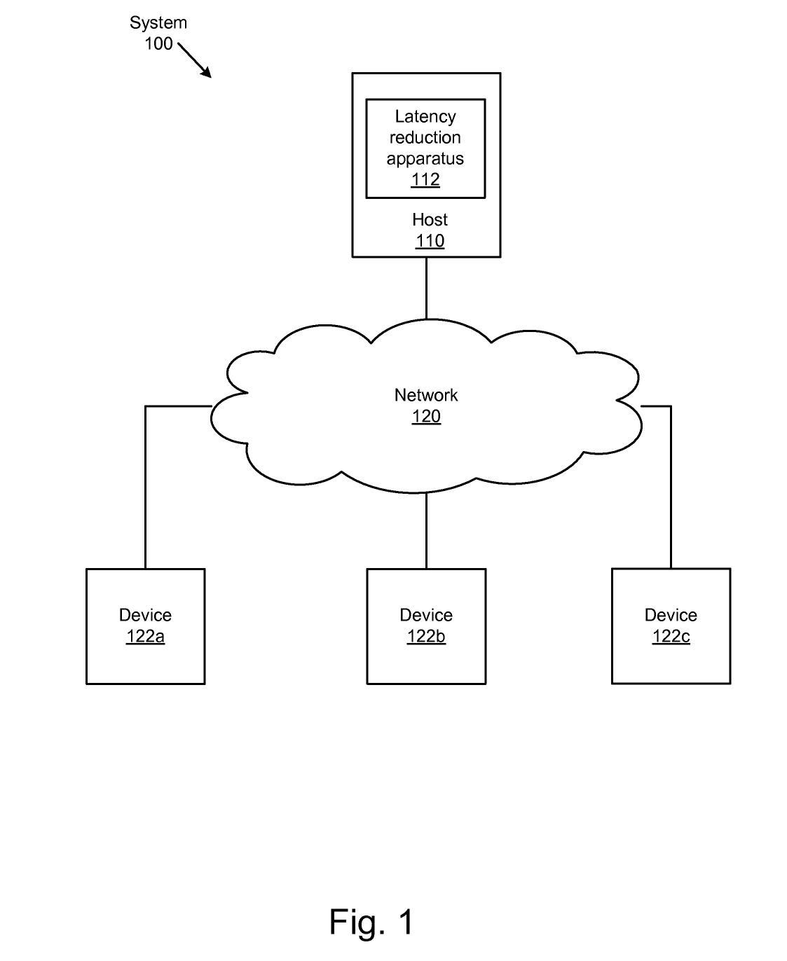

FIG. 1 illustrates a system 100 for reducing latency in communications over a network 120. The system includes a host 110, a network 120, and devices 122a-c. The host 110 is a host computing device that communicates with one or more of the devices 122a-c on the network 120. In one embodiment, the host 110 is an IBM system z series mainframe computer such as the IBM System z10. In an alternative embodiment, the host 110 is a standard computing system such as a desktop computer, server, or a server system such as a blade server.

The system 100 also includes a network 120. In one embodiment, the network 120 is a local area network (LAN). The network 120 may also be a wide area network (WAN) or some combination of LANs and WANs. In one embodiment, the network 120 is part of the Internet and the host 110 communicates over the network 120 using an Internet protocol suite such as TCP/IP. The network 120 may include various additional devices such as gateways, routers, switches, and other devices 122a-c known to those in the art.

Devices 122a-c encompass a variety of computing devices that communicate over a network 120. In one embodiment, devices 122a-c are computers communicating information over the network 120. The devices 122a-c maybe personal computers, servers, clients of the host 110, mobile devices, or other computing devices known in the art. The devices 122a-c send data to the host 110 and receive data from the host 110. In one embodiment, the data is transmitted as packets over the network 120.

The host 110 includes a latency reduction apparatus 112 that reduces the latency involved in transmitting data from the host 110 to the devices 122a-c and in receiving data from the devices 122a-c. As a result, the latency reduction apparatus 112 reduces the amount of time it takes to transmit data from the network 120 to the host 110 and, conversely, the time it takes to send data from the host 110 to the network 120. The latency reduction apparatus 112 focuses on reducing the time spent by the host 110 in processing data coming from, or sent to, the network 120. In such an embodiment, the latency reduction apparatus 112 focuses exclusively on data processing performed by the host 110. As a result of the operations of the latency reduction apparatus 112, data packets move more quickly from the host 110 to a device 122a-c or, conversely, from a device 122a-c to the host 110.

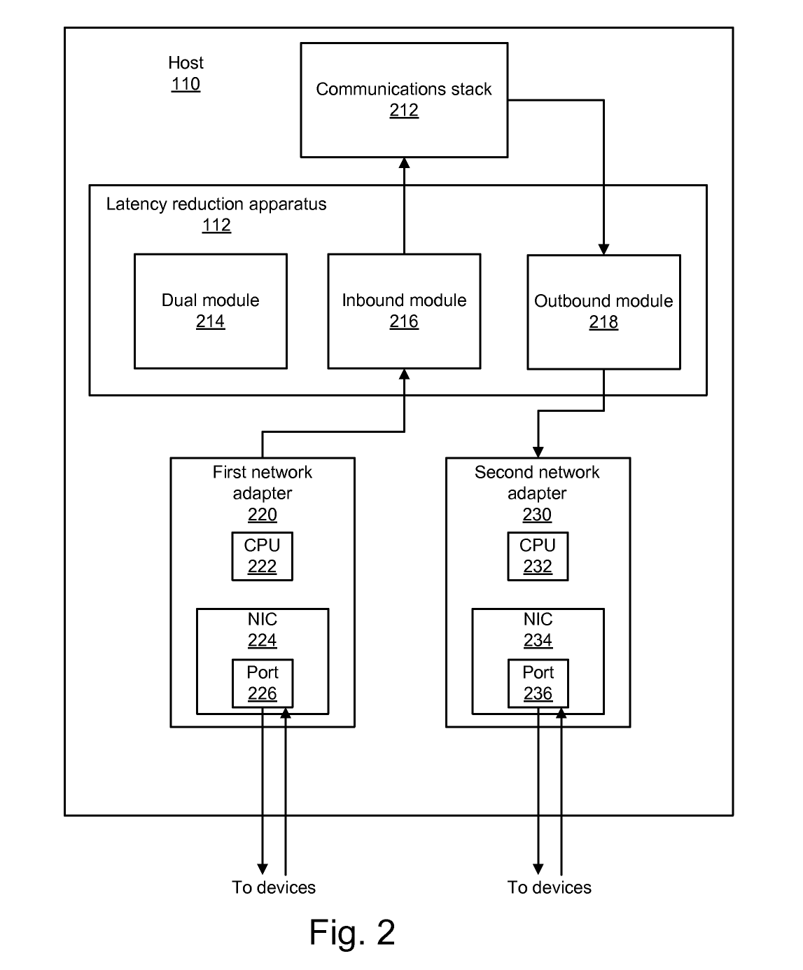

FIG. 2 is a schematic block diagram illustrating one embodiment of a host 110 including a latency reduction apparatus 112. The host 110 also includes a communications stack 212, a first network adapter 220, and a second network adapter 230. As shown, the host 110 communicates data with one or more devices such as the devices 122a-c over a network 120.

Communications stack 212 (also referred to as a protocol stack) is an implementation of a computer network protocol suite. Communications to the host 110 over the network 120, and communications to network-attached devices (such as devices 122a-c) from the host, pass through the various layers of the communications stack 212. Applications operating on the host 110 that seek to send data over the network do so through the communications stack 212. Similarly, applications receive information through the communications stack 212. The latency reduction apparatus 110 works in connection with the communications stack 212 to facilitate passing data through the host 110 in a manner that reduces latency. Those of skill in the art will appreciate that the latency reduction apparatus 112 and the first network adapter 220, along with the second network adapter 230, may be considered part of the communications stack 212. To facilitate explanation, these aspects are shown as separate to teach the particular implementation.

The host 110 also includes a first network adapter 220. The network adapter 220 is hardware that facilitates connecting the host 110 with the network 220 and facilitates communications between the two. In one embodiment, the first network adapter 220 supports many networking transport protocols and directly connects to the host 110's central processor complex I/O bus. The first network adapter 220 includes a central processing unit (CPU) 222 that provides the necessary processing for transferring data through the first network adapter 220. In typical embodiments, the first network adapter 220 also includes memory (not shown) to support the services provided by the first network adapter 220. In one embodiment, the first network adapter 220 has only one CPU 222. In another embodiment, the first network adapter 220 has multiple CPUs 222.

The first network adapter 220 also includes a network interface card (NIC) 224 to facilitate communications over the network. The NIC 224 includes at least one port 226. In certain embodiments, the first network adapter 220 provides multiple ports 226. In one embodiment, the port 226 is an Ethernet port that provides separate physical connections for inbound and outbound communications. In one embodiment, the NIC 224 is a bimodal NIC card. In alternative embodiments, the NIC 224 is a single mode NIC card.

The first network adapter 220 provides the host 110 access to the NIC 224, which provides connectivity to the external network 120, such as a LAN. In certain embodiments, the first network adapter 220 provides virtualization capability of the port 226 such that multiple logical partitions on the host 110 can simultaneously share the single physical port 226. The first network adapter 220 connects to a bidirectional communications connection such as Ethernet. The bidirectional communications connection supports data moving in both the inbound and outbound directions. Where the bidirectional communications connection is Ethernet, the present invention is implemented such that the two network adapters work together in a manner that is transparent to external LAN equipment. As such, no changes to the IEEE Ethernet standards are required.

As such, the first network adapter 220 is a hardware platform and operating system with multiple resources to manage. The first network adapter 220 interfaces with both the host (e.g., STI interface) and the network (e.g., PCI interface). In addition, the first network adapter 220 must concurrently service both inbound and outbound communications for the host 110's operations. In one embodiment of the present invention, the first network adapter 220 is an IBM Open Systems Adapter (OSA) card that operates an IBM series z mainframe computer.

When the first network adapter 220 handles communications, it can only service one of the two directions (inbound or outbound) at a time as noted above. Thus, when inbound data is being processed, outbound data is being queued. The first network adapter 220 must then switch contexts and process the outbound data. The context switching process introduces latency and delay into the system. This problem is particularly acute when the first network adapter 220 has only a single CPU 222 such that the CPU 222 cannot focus on a particular direction.

Similarly, while the first network adapter 220 may include a NIC 224 with multiple ports 226, the latency problem caused by the overhead associated with context switching remains. Thus, simply adding additional ports 226 does not reduce the latency problems; to the contrary, to the extent that the additional ports 226 introduce additional traffic, the additional ports serve only to exacerbate the problem.

The second network adapter 230 also includes a CPU 232, a NIC 234, and a port 236. The second network adapter 230 provides functionality similar to that described for the first network adapter 220. In one embodiment, the first network adapter 220 and the second network adapter 230 are identical.

To reduce the latency involved in communicating with the host 110 over a network 120, the host 110 includes a latency reduction apparatus 112 as described above. In one embodiment, the latency reduction apparatus 112 includes a dual module 214, an inbound module 216, and an outbound module 218. In one embodiment, the dual module 214, inbound module 216, and outbound module 218 are implemented at the device driver level of the host 110's operating system.

The dual module 214 represents the first network adapter 220 and the second network adapter 230 as a single logical interface. Thus, the host 110 sees only a single logical interface, i.e., a single device, when it is sending and receiving data over the network 120. The fact that there are two separate network adapters is hidden from the host 110. In one embodiment, the dual module 214 represents the two network adapters as if they were a single network adapter. In such an embodiment, the host 110 sends data communications to the single network adapter (which is actually both the first network adapter 220 and the second network adapter 230) presented by the dual module 214 and receives data communications from the single network adapter.

In one embodiment, the dual module 214 presents a single logical interface by advertising the MAC address of the first network adapter 220 to the host 110 and to devices 122a-c on the network. In such an embodiment, the MAC address of the first network adapter 220 is represented as the MAC address for the single network adapter of the host 110. The dual module 214 simultaneously hides the MAC address of the second network adapter from the host 110 and the devices 122a-c. As a result, the host 110 and the devices 122a-c see only a single logical interface. In essence, the host 110 and devices 122a-c see only a single network adapter instead of both network adapters.

In one embodiment, only the MAC address of the network adapter for inbound traffic (inbound MAC address) is advertised to the local switch and the LAN. When using the Ethernet ARP (Address Resolution Protocol) processing, the system will respond to all ARP requests using the inbound MAC address for all ARP requests for all IP addresses associated with this entire system. Therefore, the local switch will only be aware of and route packets to the inbound port using the single MAC address. When the outbound network adapter sends data it must also send an ARP request. The outbound ARP processing will always use the same single IP address associated with the physical link of the adapter along with the outbound MAC address. It will never expose the IP addresses (VIPAs) associated with higher layer resources (applications). The way to route traffic to the VIPAs from the external network is via the inbound adapter (port).

The inbound module 216 is configured to direct inbound data, such as data packets, that are sent to the single logical interface by the devices 122a-c, exclusively through the first network adapter 220. Thus, data coming off of the network 120 is routed only through the first network adapter 220 and inbound data does not pass through the second network adapter 230.

The outbound module 218 is configured to direct outbound data that is sent to the single logical interface by the host 110 exclusively through the second network adapter 230. Thus, data going onto the network is routed only through the second network adapter 230 and does not pass through the first network adapter 220.

As a result, the first network adapter 220 is used exclusively for inbound data communications while the second network adapter 230 is used exclusively for outbound data communications. Since each network adapter 220,230 has a specified direction for data communications, neither network adapter 220,230 has to engage in context switching, which reduces the overhead and resultant latency in communications through the first network adapter 220 and the second network adapter 230.

In such an embodiment, the bidirectional capabilities of Ethernet are not being fully realized. Since each port 226, 236 is used only for a single direction, the connections supporting one of the two directions is left unused. As a result, the full bandwidth potential of a host 110 incorporating two network adapters is unrealized. This is in contrast to conventional pairings, which advertise the existence of all components and which make full use of both the inbound and outbound capabilities of each network adapter. Similarly, in one embodiment, the present invention does not attempt to load balance traffic over the two routes.

In certain embodiments, the first network adapter 220 includes a NIC 224 with multiple ports 226. In such embodiments, as described above, traffic may come in through the multiple ports 226; however, the traffic is exclusively inbound data communications. A second network adapter 230 may similarly include multiple ports 236 that each exclusively facilitates outbound data communications.

Certain embodiments may also include a host 110 that does not use a network adapter for communications. For example, a host 110 that is a personal computer may include NICs 224 and 234 without the associated network adapters 220 and 230 respectively. In such embodiments, the NICs 224 and 234 connect to the host 110 via a bus such as PCI or others known to those in the art. The dual module 214, inbound module 216, and outbound module 218 provide the services described above, but for the NIC 224 and NIC 234 directly.

Thus, the host 110 can communicate with devices on the network via the bidirectional communication connections described above with minimal latency. The host 110 may be directly connected to the devices, or may alternatively be indirectly connected to the relevant devices by one or more entities on the network. In either embodiment, the data is communicated between the host 110 and the devices over the network. In addition, the bidirectional communication connection need only be the one directly into the host 110. Other communication paths on the network may be unidirectional.

In one embodiment, the outbound module 218 intercepts data sent by the host 110 to the first network adapter 220 and redirecting the data to the second network adapter 230. For example, as described above, the dual module 214 may advertise to the host 110 and to the devices the MAC address of the first network adapter 220 such that the relevant devices see only the first network adapter 220. In such an embodiment, the host 110 sends data to the first network adapter 220 when it wants to communicate information over the network. The outbound module 218 intercepts these communications before they reach the first network adapter 220 and reroutes the data through the second network adapter 230. By intercepting and rerouting the data, the outbound module 218 works in cooperation with the dual module 214 to implement the present invention in a manner that is transparent to the host 110 and the devices; that is, neither the host 110 nor the devices are aware of any intercepting and rerouting of messages.

In a further embodiment, the present invention takes advantage of the specialized behavior of the first network adapter 220 and the second network adapter 230 to realize additional performance gains. That is, since the first network adapter 220 exclusively handles inbound data sent by devices to the host 110, the first network adapter 220 can be optimized for inbound traffic without concern for how such optimization affects outbound traffic handling by the first network adapter 220. Similarly, the second network adapter 230 can be optimized for outbound traffic sent from the host 110 since second network adapter 230 does not handle inbound traffic.

In one embodiment, the first network adapter 220 is optimized for inbound data communications based on interrupt optimization for the inbound direction. Similarly, the second network adapter 220 is optimized for outbound data communications based on interrupt optimization for the outbound direction. Approaches for performing interrupt optimization are described in the patent application of Maurice Isrel Jr., Bruce H. Ratcliff, Jerry W. Stevens and Edward Zebrowski Jr. entitled “Network Adaptor Optimization and Interrupt Reduction” with application Ser. No. 12/326,468 filed on Dec. 2, 2008, which application is incorporated herein by reference.

As a result of the described embodiments, the latency reduction apparatus 112 reduces the latency associated with communicating information to the host 110 and from the host 110. The present invention presents the two network adapters as a single logical interface to both the host 110 and the devices; that is, both the host 110 and the network devices behave as if there were only a single network adapter. In reality, there are multiple network adapters, and at least one of those network adapters is dedicated exclusively to inbound traffic. Conversely, at least one of the network adapters is dedicated exclusively to outbound traffic. This is accomplished by limiting the bidirectional communications path into the network adapters (such as Ethernet) to only a single direction, effectively leaving one direction unused. This partial use of the abilities of Ethernet does not allow the host 110 to take full advantage of the bandwidth available; however, in accordance with the present invention, it facilitates the reduction of communication latency.

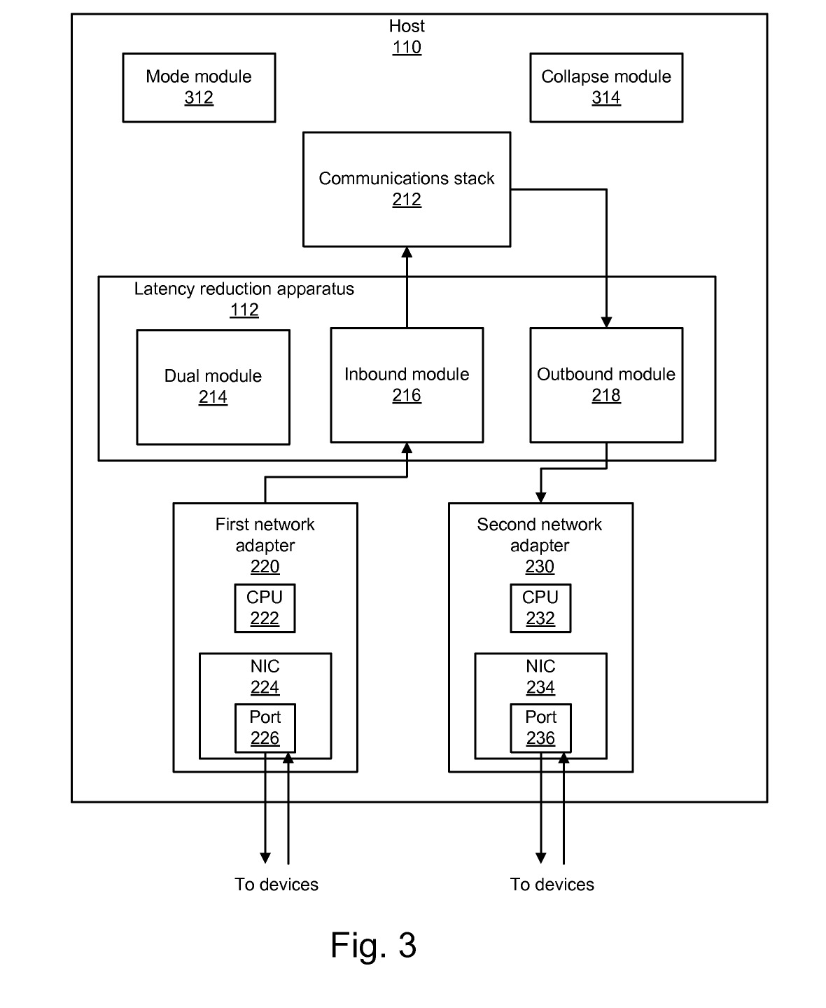

FIG. 3 shows an additional embodiment of a host 110 including a dual module 214, inbound module 216, and outbound module 218 as described above in connection with FIG. 2. FIG. 3 also illustrates a mode module 312 and a collapse module 314.

The mode module 312 provides the administrator of the host 110 system with the ability to activate and deactivate the dual module 214, inbound module 216, and outbound module 218 to perform the functions described above in FIG. 2. In one embodiment, the mode module 312 provides a graphical user interface (GUI) to facilitate selection and configuration of a latency reduction mode that activates the latency reduction apparatus 112. The user of the host 110 system may alternatively access the functions of the mode module 312 using a command line interface or other interface known to those in the art.

When the user selects a latency reduction mode, the mode module 312 enables the latency reduction apparatus 112 such that the dual module 214, inbound module 216, and outbound module 218 operate to reduce latency in communications as described above in connection with FIG. 2. When the user selects a ‘normal’ mode for the host 110, the mode module 312 deactivates the dual module 214, inbound module 216, and outbound module 218. In one embodiment, the mode module 312 configures the first network adapter 220 and the second network adapter 230 to work simultaneously as paired network adapters that both handle inbound and outbound data in normal mode. In an alternative embodiment, the mode module 312 configures one of the network adapters to handle both inbound and outbound data, and deactivates the other such that only one network adapter is active on the host 110.

The host 110 also includes a collapse module 314 that enables bidirectional communication through an operational network adapter if one of the network adapters in the host 110 fails. The collapse module 314, in certain embodiments, monitors the first network adapter 220 and the second network adapter 230 for failures. In an alternative embodiment, the collapse module 314 communicates with other elements of the host 110, such as a baseboard management controller (BMC), that are responsible for monitoring the health and performance of the first network adapter 220 and the second network adapter 230.

In latency reduction mode inbound and outbound communications travel to and from the host 110 over physically separate channels. If either the first network adapter 220 or the second network adapter 230 fail while the host 110 is operating in latency reduction mode, the host 110 would be restricted to only inbound or outbound communications, depending on which network adapter failed. The collapse module 314 detects which network adapters remains operational after one of the network adapters fails, and ensures that the host 110 has both inbound and outbound data paths. Where there are two network adapters, as shown in FIG. 3, the collapse module alters the operations of the operational network adapter 220, 230 such that the operational network adapter 220, 230 handles both inbound and outbound data communications. As a result, a failure in one network adapter does not disable communications between the host 110 and the devices. The collapse module 314 ensures that there is always an active inbound data path and an active outbound data path.

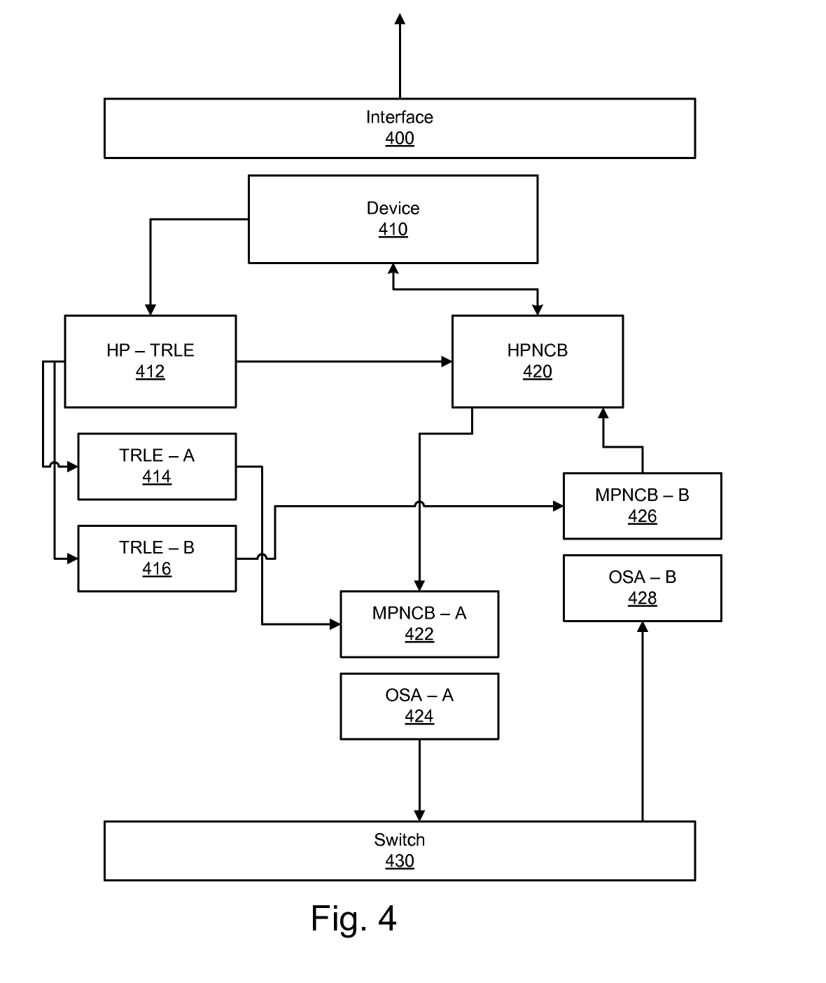

FIG. 4 illustrates one embodiment of an implementation of the present invention. While illustrative of one approach, FIG. 4 and the accompanying discussion is not intended to limit the claimed invention to the particular implementation described herein. FIG. 4 illustrates the interface 400 to the host 110 described above. Communications from the communications stack pass through the single logical interface 400. In one embodiment, upper layers of the stack see a single interface 400 while lower layers, such as hardware, see the individual physical interfaces to the separate network adapters, which in this case are OSA-A 424 and OSA-B 428. Thus, the interface 400 is implemented such that it is transparent to the host and to network attached devices. As a result, the presented solution does not require network routing changes in the local host or remote hosts. Nor does the solution cause changes to route processing. For example, in a z/OS embodiment, the z/OS CommServer IP layer route table, static route definitions, routing daemon (OMPRoute) functionality and routing protocols only see a single interface or route.

As a result, the host and network devices see only the device 410; however, the device 410 is actually multiple devices (such as OSA-A 424 and OSA-B 428). The user interacts with the invention as if it were only a single device; thus, a command that affects the device 410 (such as a command to stop the device 410) is replicated and directed to all physical devices. However, in one embodiment, management tools and diagnostic tools can access and process both OSA-A 424 and OSA-B 428 separately.

Also illustrated is a HiperPath Transport Resource List Entry (HP-TRLE) 412 in accordance with the present invention. In the z/OS environment, TRLEs are tables or lists of devices defined by a user that identify the multi-path channel (MPC) group of queued direct input/output (QDIO) devices. The HP-TRLE 412 is defined to define a new group consisting of OSA-A 424 and OSA-B 428 which are the inbound and outbound ports. The HP-TRLE 412 points to the two existing TRLEs (TRLE-A 414 and TRLE-B 416) that are associated with OSA-A 424 and OSA-B 428 respectively.

FIG. 4 also illustrates a new node control block (NCB) which is the HiperPath NCB 420. In one embodiment, the HPNCB 420 is defined at the data link control (DLC) level. The HPNCB 420 represents to the stack the single device 410 and serves as the main control block into the DLC. The HPNCB 420 groups the two existing NCBs (MPNCB-A 422 and MPNCB-B 426) associated with OSA-A 424 and OSA-B 426 into a single group. The HPNCB 420 duplicates and coordinates signaling to and from the stack to the MPNCB-A 422 and MPNCB-B 426.

Thus, the communications stack views the HPNCB 420 as the single device 410. From the perspective of the lower layers in the stack (such as the QDIO DLC device perspective) the HPNCB 420 is the host. Thus, the HPNCB 420 provides a layer of abstraction that hides the fact that there are, in fact, two separate network adapters OSA-A 424 and OSA-B 426. Data communications coming in from the switch 430 and going out through the switch 430 are thus directed through the separate network adapters as described above.

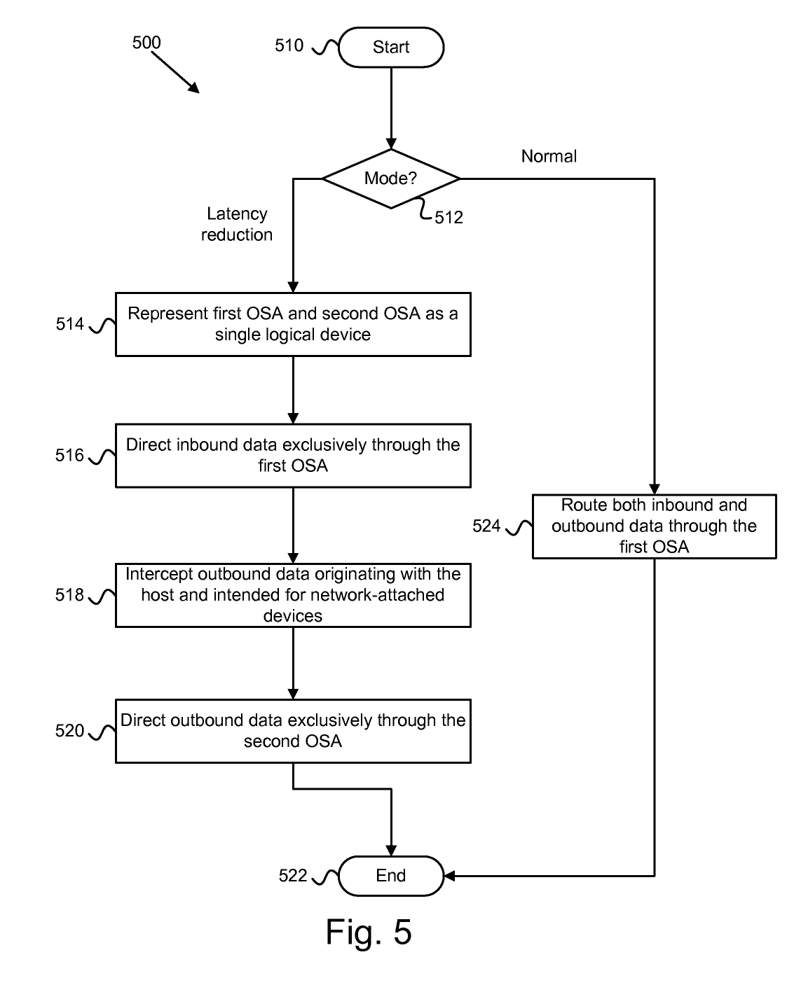

FIG. 5 illustrates one embodiment of a method 500 for reducing latency in communications between a host and network attached computing devices. FIG. 5 is not intended to limit methods for performing the present invention to any particular order. In addition, steps may be omitted or added to the method without departing from the spirit of the present invention. The method 500 begins 510 with a determination 512 of the mode for the host 110. In one embodiment, the mode module 312 sets the mode for the host 110.

If the mode is set to latency reduction mode, the method 500 includes representing 514 the first OSA and the second OSA as a single logical device. In one embodiment, the dual module 214 represents the first OSA and the second OSA as a single logical device to the host and to network-attached devices. As a result, data sent to the host 110 by devices on the network are directed to the single logical device; similarly, data sent by the host 110 to the network-attached devices are sent to the single logical device.

The method 500 also includes directing 516 inbound data communications sent to the host 110 exclusively through the first OSA. In one embodiment, the inbound module 216 is responsible for directing the inbound data packets through the first OSA such that no inbound data packets pass through the second OSA. The host 110 sends the outbound data to the single logical device.

The outbound module 218 intercepts 518 outbound data packets originating with the host 110 and sent to network-attached devices. In one embodiment, the single logical device is advertised as having the MAC address of the first OSA. As such, outbound data is sent from the host 110 to the first OSA, and the outbound module 218 intercepts the outbound data packets prior to the outbound data packets reaching the first OSA and redirects them through the second OSA as described below.

The method 500 also includes the outbound module 218 directing 520 outbound data exclusively through the second OSA such that no outbound data packets pass through the first network adapter. As a result, each OSA handles communications traffic in only a single direction and does not have to engage in context switching. In addition, each OSA can be optimized for data communications in the specified direction without concern for the effects that such optimization could have if the OSA had to process communications in the other direction.

If the mode 512 is set to normal, both inbound and outbound data are routed 524 through the first OSA. In an alternative embodiment, both inbound and outbound data communications are routed through both the first and the second OSA when the mode is set to normal. Normal mode may be optimized for bandwidth, or use the first and the second OSA for load balancing.

In certain embodiments, the method 500 also includes monitoring the first OSA and the second OSA and enabling bidirectional communications through whichever OSA remains operational if one of the OSAs fails. As a result, in the event of a failure, both inbound and outbound data packets are directed through the operational network adapter such that it repeatedly switches directions to communicate both inbound and outbound data packets over the network.

What is claimed is:

1. An apparatus for reducing latency in communications over a network comprising:
a dual module configured to represent a first network adapter and a second network adapter as a single logical interface to a host comprising the first network adapter and the second network adapter and to one or more devices communicating data with the host over a network, wherein the first network adapter comprises a first port and a first network interface card (NIC), the first network adapter supporting bidirectional communication, and wherein the second network adapter comprises a second port and a second NIC, the second network adapter also supporting bidirectional communication;
an inbound module configured to direct inbound data sent to the single logical interface by one or more devices over the network exclusively through the first network adapter; and
an outbound module configured to direct outbound data sent to the single logical interface by the host exclusively through the second network adapter.

2. The apparatus of claim 1, wherein directing outbound data exclusively through the second network adapter comprises the outbound module intercepting outbound data sent by the host to the first network adapter and directing the outbound data exclusively through the second network adapter.

3. The apparatus of claim 1, wherein the first network adapter is an Open System Adapter (OSA) optimized for inbound data communications in a mainframe computing environment, and the second network adapter is an OSA optimized for outbound data communications in a mainframe computing environment.

4. The apparatus of claim 3, wherein the first OSA is optimized for inbound data communications based on interrupt optimization for the inbound direction, and wherein the second OSA is optimized for outbound data communications based on interrupt optimization for the outbound direction.

5. The apparatus of claim 1, wherein the dual module, inbound module, and outbound module are implemented at a device driver level.

6. The apparatus of claim 1, further comprising a mode module configured to activate the dual module, inbound module, and outbound module in response to a user selecting a latency reduction mode for the host, and wherein the mode module is further configured to deactivate the dual module, inbound module, and outbound module in response to the user selecting a normal mode for the host.

7. The apparatus of claim 1, further comprising a collapse module configured to enable bidirectional communication through an operational network adapter in response to one of the first network adapter and the second network adapter failing, and wherein the operational network adapter is one of the first and second network adapters.

8. The apparatus of claim 7, wherein enabling bidirectional communication comprises directing inbound data sent to the host by one or more devices over the network through the active network adapter and directing outbound data sent by the host to one or more devices on the network through the active network adapter such that the network adapter repeatedly switches directions to communicate both the inbound and outbound data.

9. The apparatus of claim 1, wherein the dual module representing the first network adapter and the second network adapter as a single logical interface further comprises the dual module advertising to the network and to the host the MAC address of the first network adapter and hiding from the network and the host the MAC address of the second network adapter.

10. The apparatus of claim 1, wherein the host is connected to the network by a bidirectional Ethernet connection compliant with Ethernet protocol.

11. A system for reducing latency comprising:
a first Open Systems Adapter (OSA) comprising one processor, a first port, and a first network interface card (NIC), the first OSA supporting bidirectional Ethernet communication, wherein the first OSA is optimized for inbound data communications using interrupt optimization;
a second Open Systems Adapter (OSA) comprising one processor, a second port, and a second network interface card (NIC), the second OSA supporting bidirectional Ethernet communication, wherein the second OSA is optimized for outbound data communications using interrupt optimization;
a dual module configured to represent the first OSA and the second OSA as a single logical interface to a host and to one or more devices communicating data with the host over a bidirectional Ethernet connection;
an inbound module configured to direct inbound data sent to the host by one or more devices over the network exclusively through the first OSA; and
an outbound module configured to intercept outbound data sent by the host to one or more devices on the network through the first OSA and to direct the outbound data exclusively through the second OSA.

12. The system of claim 11, wherein the dual module, inbound module, and outbound module are implemented at a device driver level.

13. The apparatus of claim 11, further comprising a mode module configured to activate the dual module, inbound module, and outbound module in response to a user selecting a latency reduction mode for the host, and wherein the mode module is further configured to deactivate the dual module, inbound module, and outbound module in response to the user selecting a normal mode for the host.

14. The apparatus of claim 11, further comprising a collapse module configured to enable bidirectional communication through an operational network adapter in response to one of the first network adapter and the second network adapter failing, and wherein the operational network adapter is one of the first and second network adapters.

15. The apparatus of claim 14, wherein enabling bidirectional communication comprises directing inbound data sent to the host by one or more devices over the network through the active network adapter and directing outbound data sent by the host to one or more devices on the network through the active network adapter such that the network adapter repeatedly switches directions to communicate both the inbound and outbound data.

16. The apparatus of claim 11, wherein the dual module representing the first OSA and the second OSA as a single logical interface further comprises the dual module advertising to one or more devices connected to the network and to the host the MAC address of the first OSA and hiding from the network and the host the MAC address of the second OSA.

17. A method for reducing latency in communications over a network comprising:
representing a first network adapter and a second network adapter as a single logical interface to a host comprising the first network adapter and the second network adapter;
wherein the first network adapter comprises a port, a network interface card (NIC), and only one central processing unit (CPU), and wherein the second network adapter comprises a port, a NIC, and only one CPU;
directing inbound data packets originating on the network and addressed to the host exclusively through the first network adapter such that no inbound data packets pass through the second network adapter; and
intercepting outbound data packets sent by the host to the first network adapter prior to the outbound data packets reaching the first network adapter and directing the outbound data packets exclusively through the second network adapter such that no outbound data packets pass through the first network adapter, the inbound data originating with the host and addressed to one or more devices on the network.

18. The method of claim 17, further comprising optimizing the first network adapter for inbound data communications based on interrupt optimization for the inbound direction, and optimizing the second network adapter for outbound data communication based on interrupt optimization for the outbound direction.

19. The method of claim 17, further comprising enabling bidirectional communication through an operational network adapter in response to one of the first network adapter and the second network adapter failing, and wherein the operational network adapter is one of the first and second network adapters.

20. The method of claim 19, wherein enabling bidirectional communication comprises directing inbound data packets through the operational network adapter and directing outbound data packets through the operational network adapter such that the operational network adapter repeatedly switches directions to communicate both the inbound data packets and the outbound data packets over the network.
